(19) United States
(12) Patent Application Publication
(10) Pub. No.: US 2011/0085266 A1
(43) Pub. Date: Apr. 14, 2011

(54) PERPENDICULAR MAGNETIC RECORDING HEAD

(75) Inventors: Yasushi KANAI, Niigata (JP); Yoshihiro JINBO, Niigata (JP)

(73) Assignee: Kazuyoshi YAMAMORI, Tokyo (JP)

(21) Appl. No.: 12/773,575

(22) Filed: May 4, 2010

(30) Foreign Application Priority Data
Oct. 13, 2009 (JP) 2009-236528

(51) Int. Cl. G11B 5/127

(52) U.S. Cl. 360/125.03; G9B/5.04

(57) ABSTRACT

A perpendicular magnetic recording head is provided, which has a head structure that narrows the erase band width in shingled write recording. A perpendicular magnetic recording head has a main pole that generates a recording magnetic field, a trailing shield positioned on the trailing side of the main pole, and a side shield positioned in the cross-track direction of the main pole. In the structure, a gap length (MP−SS distance) between the side shield and the main pole and a gap length (MP−TS distance) between the trailing shield and the main pole satisfy a relationship, (MP−TS distance)×0.5<(MP−SS distance)<(MP−TS distance)×1.5.

### CROSS REFERENCE TO RELATED APPLICATION

This application claims the benefit of Japanese patent application No. 2009-236528, filed in Japan on Oct. 13, 2009, the subject matter of which is hereby incorporated herein by reference.

### BACKGROUND OF THE INVENTION

1. Field of the Invention

The present invention relates to a magnetic recording head used for a perpendicular magnetic recording HDD (Hard Disk Drive) that adopts shingled write recording.

2. Description of Related Art

In order to achieve high recording density in HDDs, high linear density and track density are necessary. In the HDDs using conventional recording methods, it is necessary to form the pole-tip width of the main pole of a recording head narrower than the track width so as not to erase or weaken the signals on adjacent tracks for the purpose of realizing high track density.

FIG. 1 is a schematic diagram depicting the outline of a recording head for use in conventional technologies. FIG. 2 is a schematic diagram depicting the structure of a half cut model cut at the section indicated by a dotted line shown in FIG. 1. The recording head having side shields and a trailing shield is formed in the structure shown in FIGS. 1 and 2. FIGS. 1 and 2 are diagrams seen from the air bearing surface (ABS) of the main pole. In the conventional technologies, it is necessary to form the main-pole-tip width narrower than the track width. However, when the tip-end width of the main pole is formed narrower, a generable recording field strength is decreased and it is often difficult to write data on a recording medium having a high coercivity (anisotropic magnetic field). On this account, a recording medium having a small coercivity (anisotropic magnetic field) has to be used. Because the recording medium having a small coercivity (anisotropic magnetic field) does not have sufficient thermal stability, it is necessary to increase the grain volume of the medium. As the consequence of an increased grain volume of the recording medium, a problem arises that it is really difficult to attain high linear and areal densities.

FIGS. 3A and 3B are graphs depicting recording filed distributions calculated by micromagnetic computer simulations. FIG. 3A shows the recording filed distributions in the down-track direction when the main pole-trailing shield gap (MP−TS gap) is 60 nm, and FIG. 3B shows the recording filed distributions in the cross-track direction when the main pole-trailing shield gap (MP−TS gap) is 60 nm. The recording head having the conventional structure is designed to form the main pole-side shield gap (MP−SS gap) sufficiently wider than the main pole-trailing shield gap (MP−TS gap) for the minimum reduction in magnetic field strength. It can be seen from FIGS. 3A and 3B that the optimum magnetic field strength can be attained at 60 nm of the MP−SS gap or wider when the MP−TS gap is 60 nm.

On the other hand, in order to solve the problem of a reduction in magnetic field strength, shingled write recording is proposed. FIG. 4 is a schematic diagram depicting a scheme to write data onto a track with a recording head according to shingled write recording. Track n is partially overwritten on a part of track n−1, and track n+1 is overwritten on the track n. Because a band-like region remaining as effective signals is the area indicated between arrows in the drawing, the region can be made narrower regardless of the main-pole width.

In shingled write recording, a recording head having a wide main-pole width is used for performing edge recording to form the track width narrower than the main-pole width, and a high track density is attained. Because the recording head having a wide main-pole width can generate a strong recording magnetic field, a high linear density can be attained and a high areal density can be achieved together with a high track density.

Patent Document 1 discloses a perpendicular magnetic recording head. The write head is single pole head including a main pole and a return pole. The main pole has a first surface facing the inside of a track of the magnetic recording layer, a second surface facing a data recording surface of the magnetic recording layer and a third surface facing the outside of the track of the magnetic recording layer, wherein the first and third surfaces may be symmetric to each other and form an angle of greater than 90 degrees with the second surface. This structure provides a perpendicular magnetic recording head with a magnetic recording layer with high track density, which can reduce the amount of leakage flux.

Patent Document 1 is JP 2008-123692 A.

Non-Patent Document 1 is a paper given by S. Greaves, H. Muraoka, and Y. Kanai, see Simulations of recording media for 1 Tb/in², Journal of Magnetism and Magnetic Materials, pp. 2889-2893, Vol. 320, No. 22, Nov. II (2008).

### SUMMARY OF THE INVENTION

However, shingled write recording described in Patent Document 1 has a problem that the erase bandwidth is broadened when the MP−SS gap is formed wider than the MP−TS gap. The term “erase band” means a band-like region formed between signal tracks and the region has useless, adversely affecting noise. It is necessary to form the erase band sufficiently narrower for attaining a high track density. In shingled write recording in which a high track density is implemented by edge recording, it is necessary to pay careful attention particularly to the erase band width.

The definition of the erase band (EB) is described with reference to FIG. 5. FIG. 5 shows the strength of the recording signal when signals were written on the center self track and two adjacent tracks on the both sides of that track. For instance, a 1494 kfci signal is written onto the two adjacent tracks on the both sides of the center self track. Then recording signal (907 kfci) is written onto the center track. After being written on the central track, the recording signal written on the adjacent tracks (1494 kfci, Start) turns into a signal accompanied with lower output and smaller writing width (1494 kfci, End). Suppose that the erase width EL is defined as a distance between the value of recording signal (1494 kfci, Start) and the value of recording signal whose output is half of 1494 kfci, Start, erase band width EB is given by subtracting the magnetic write width MWW from the erase width EL.

FIG. 6 shows a graph depicting the erase band width calculated for the perpendicular component of the recording field gradient of the head in the cross-track direction (hereinafter, referred to as the cross-track recording field gradient: CT field gradient), which was calculated by computer simulations. As seen from this figure, it is apparent that it is necessary to use a recording head having a large CT field gradient for narrowing the erase band width. It is seen from FIG. 6 that in order to form a 5-nm erase band width, it is necessary to provide a CT field gradient of 300 Oe/nm or greater. Even though the CT field gradient is made larger, it is really difficult to form a 4-nm erase band width or below because of the limitation caused by the grain size (4.5 nm) of the recording layer of a medium.

It is an object of the present invention to provide a perpendicular magnetic recording head having a head structure that narrows the erase band width, that is, a head structure that steepens the CT field gradient.

A perpendicular magnetic recording head according to a first aspect of the present invention is a perpendicular magnetic recording head for use in shingled write recording, which includes a main pole that generates a recording magnetic field, a trailing shield positioned on a trailing side of the main pole, and a side shield positioned in a cross-track direction of the main pole. In the structure, a gap length (MP−SS distance) between the side shield and the main pole and a gap length (MP−TS distance) between the trailing shield and the main pole satisfy a relationship:

(MP−TS distance)×0.5<(MP−SS distance)<(MP−TS distance)×1.5.

In a perpendicular magnetic recording head according to a second aspect of the present invention in the perpendicular magnetic recording head according to the first aspect of the present invention, the gap length (MP−SS distance) between the side shield and the main pole and the gap length (MP−TS distance) between the trailing shield and the main pole may be almost the same.

In a perpendicular magnetic recording head according to a third aspect of the present invention in the perpendicular magnetic recording head according to the first or second aspect of the present invention, the side shield may be provided only on one side of the main pole.

In a perpendicular magnetic recording head according to a fourth aspect of the present invention in the perpendicular magnetic recording head according to any one of the first to third aspects of the invention, a flare angle of the main pole may range from angles of 20 to 30 degrees.

In a perpendicular magnetic recording head according to a fifth aspect of the present invention in the perpendicular magnetic recording head according to any one of the first to fourth aspects of the invention, a two-dimensional figure of the main pole may be symmetric to the center line.

In a perpendicular magnetic recording head according to a sixth aspect of the present invention in the perpendicular magnetic recording head according to any one of the first to fourth aspects of the invention, a two-dimensional figure of the main pole may be asymmetric to the center line.

In a perpendicular magnetic recording head according to a seventh aspect of the present invention in the perpendicular magnetic recording head according to any one of the first to fourth aspects of the invention, a shape of an air bearing surface (ABS) of the main pole may be symmetric to the center line.

In a perpendicular magnetic recording head according to an eighth aspect of the present invention in the perpendicular magnetic recording head according to any one of the first to fourth aspects of the invention, a shape of an air bearing surface (ABS) of the main pole may be asymmetric to center line.

According to the present invention, in shingled write recording using a recording head having a wide main-pole width, a recording head having a wide main-pole width is used to perform edge recording, and thus a narrow erase band can be formed. On this account, the following is suggested from computer simulations. Because the track width narrower than the main-pole width can be formed to attain a high track density, the recording areal density two to three times that of conventional technologies can be achieved (for example, such data that can be obtained according to the scheme of Non-Patent Document 1).

### BRIEF DESCRIPTION OF THE DRAWINGS

The teachings of the present invention can be readily understood by considering the following detailed description in conjunction with the accompanying drawings, in which:

FIG. 1 is a schematic diagram depicting the outline of a recording head for use in conventional technologies;

FIG. 2 is a schematic diagram depicting the structure of a half cut model cut at the section indicated by a dotted line shown in FIG. 1;

FIGS. 3A and 3B are graphs depicting recording filed distributions calculated by micromagnetic computer simulations, FIG. 3A is a graph depicting recording filed distributions in the down-track direction when MP−TS=60 nm, and FIG. 3B is a graph depicting recording filed distributions in the cross-track direction when MP−TS=60 nm;

FIG. 4 is a schematic diagram depicting a scheme to write a track with a recording head according to shingled write recording;

FIG. 5 is a graph depicting written signal strengths observed on a track at the center and two adjacent tracks on both sides of that track when signals were written onto the tracks;

FIG. 6 is a graph depicting the relation between the CT field gradient and the erase band width calculated by computer simulations;

FIG. 7 is a schematic diagram depicting the structure of a perpendicular magnetic recording head according to a first embodiment of the present invention;

FIG. 8 is a graph depicting the dependencies on the MP−SS distance of the recording field strength, the recording field gradient in the down-track direction, the recording field gradient in the cross-track direction, and the stray field strength to the adjacent track, which were calculated by computer simulations;

FIG. 9 is a graph depicting the dependencies on the MP−TS distance of the recording field strength, the recording field gradient in the down-track direction, the recording field gradient in the cross-track direction, and the stray field strength to the adjacent track, which were calculated by computer simulations;

FIG. 10 is a graph depicting the dependencies on the flare angle of the main pole of the recording field strength, the recording field gradient in the down-track direction, the recording field gradient in the cross-track direction, and the stray field strength to the adjacent track, which were calculated by computer simulations;

FIG. 11 is an enlarged diagram depicting a perpendicular magnetic recording head according to an exemplary embodiment of the first embodiment of the present invention, which is seen from the ABS;

FIG. 12 is a schematic diagram depicting the outline of the perpendicular magnetic recording head according to the exemplary embodiment of the first embodiment of the present invention;

FIGS. 13A and 13B are schematic plane views depicting two-dimensional figures of main poles of perpendicular magnetic recording heads according to the first embodiment and a second embodiment of the present invention;

FIG. 14 shows diagrams depicting magnetic filed distributions illustrating recording field strengths when the perpendicular magnetic recording head according to the first embodiment of the present invention has a skew angle;

FIG. 15 is a schematic diagram depicting a perpendicular magnetic recording head according to a third embodiment of the present invention when the ABS shape of a main pole of the perpendicular magnetic recording head is asymmetric to the center line; and

FIG. 16 is an illustration depicting flare angles.

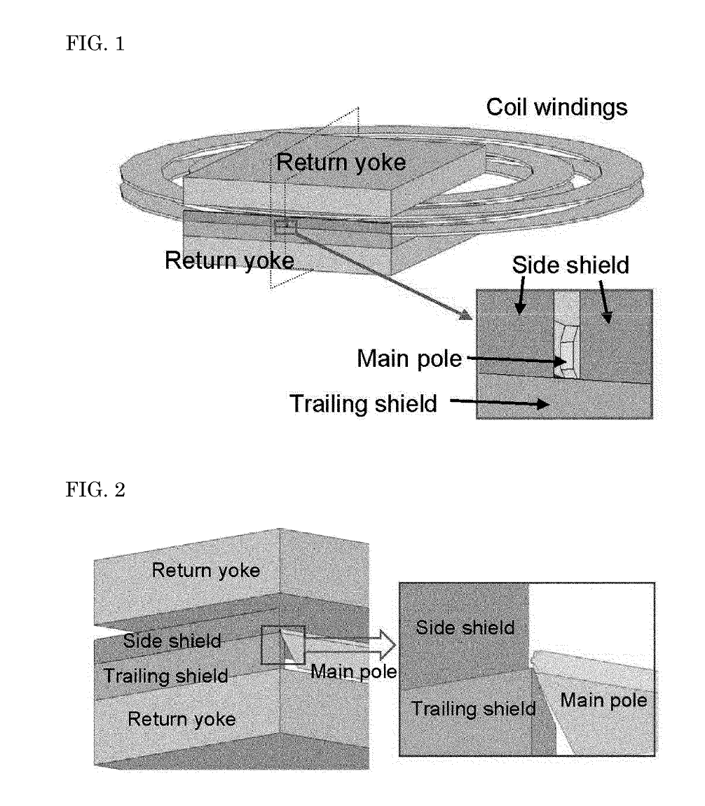

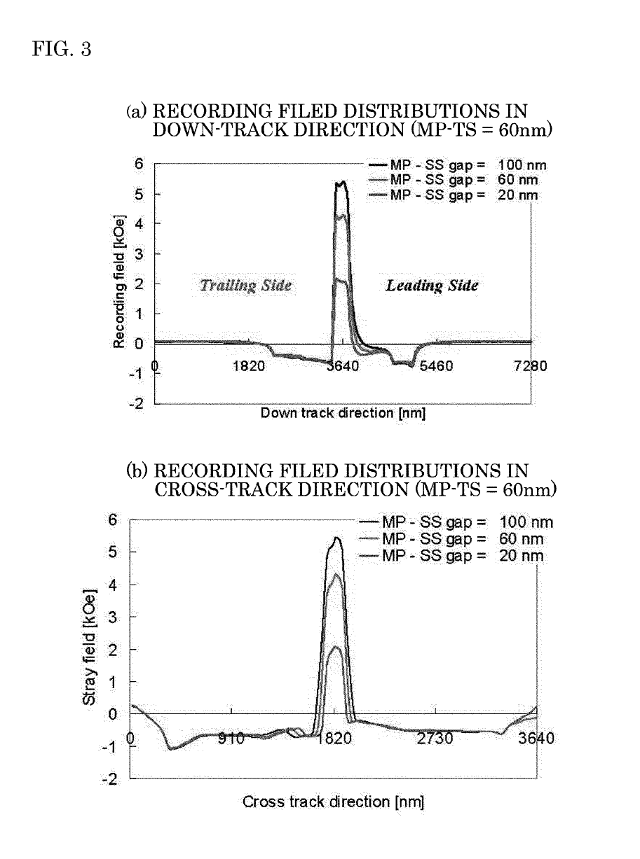

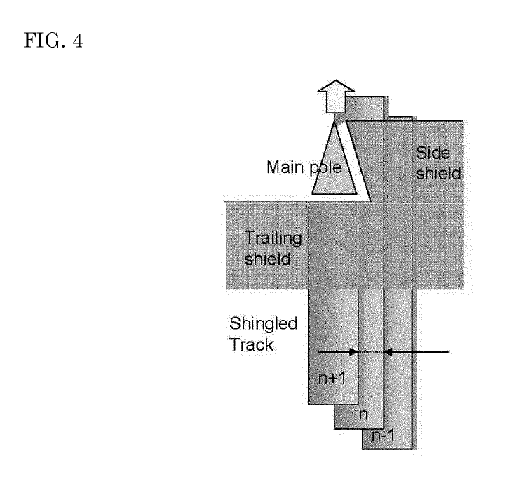

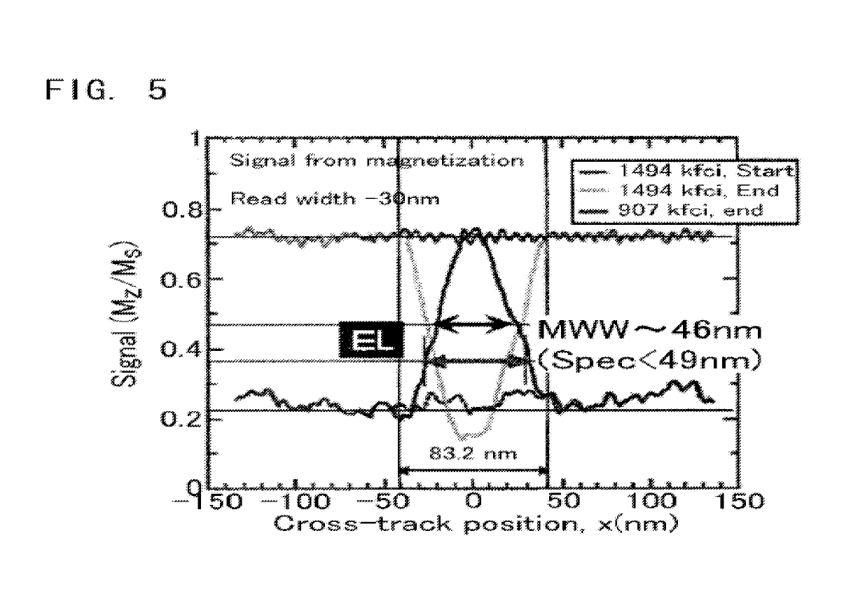

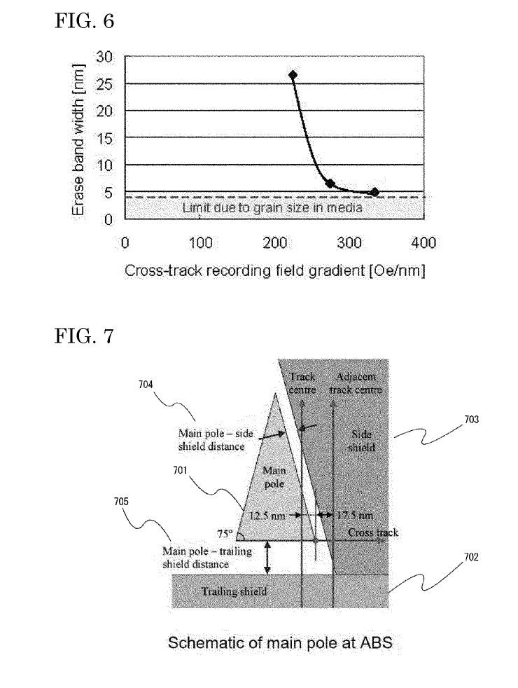

### DETAILED DESCRIPTION OF THE INVENTION

Hereinafter, exemplary embodiments of the present invention are described in detail with reference to the drawings. The present invention should not be limited to the embodiments described below.

### I. First Embodiment

### 1. Structure of a Perpendicular Magnetic Recording Head

The structure of a perpendicular magnetic recording head according to a first embodiment of the present invention is described with reference to FIG. 7. As shown in FIG. 7, the perpendicular magnetic recording head is a perpendicular magnetic recording head for use in shingled write recording, which has a main pole 701 that generates a recording magnetic field, a trailing shield 702 positioned on the trailing side of the main pole 701, and a side shield 703 positioned in the cross-track direction of the main pole 701. In this structure, a gap length (MP−SS distance) 704 between the side shield 703 and the main pole 701 and a gap length (MP−TS distance) 705 between the trailing shield 702 and the main pole 701 satisfy a relationship below:

(MP−TS distance)×0.5<(MP−SS distance)<(MP−TS distance)×1.5.

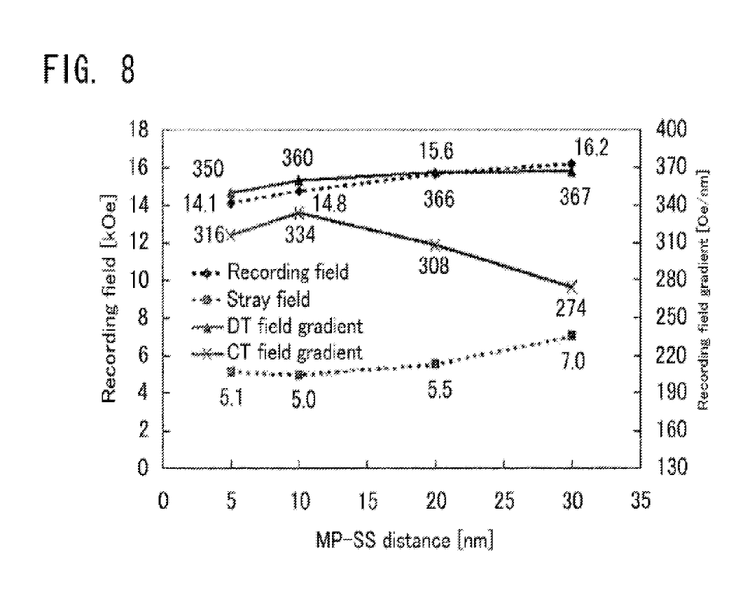

FIG. 8 is a graph depicting the dependencies on the MP−SS distance of the recording field strength, the recording field gradient in the down-track direction, the recording field gradient in the cross-track direction, and the stray field strength to the adjacent track, which were calculated by computer simulations, where the MP−TS distance was 10 nm.

It is shown from FIG. 8 that the perpendicular component of the recording field gradient of the head in the down-track direction (hereinafter, referred to as the down-track recording field gradient: DT field gradient) was gradually reduced as the MP−SS distance became small. On the other hand, when attention is focused on the CT field gradient, the CT field gradient became large as the MP−SS distance became small, and the CT field gradient took the maximum value near 10 nm, and it was reduced at 5 nm. Therefore, it is necessary to provide the MP−SS distance ranging from 5 to 15 nm such that the degradation of the DT field gradient falls within a slight range while the CT field gradient becomes large. In other words, it is necessary to satisfy the following relationship:

(MP−TS distance)×0.5<(MP−SS distance)<(MP−TS distance)×1.5.

As described later, the following case is the most desirable:

(MP−SS distance)=(MP−TS distance).

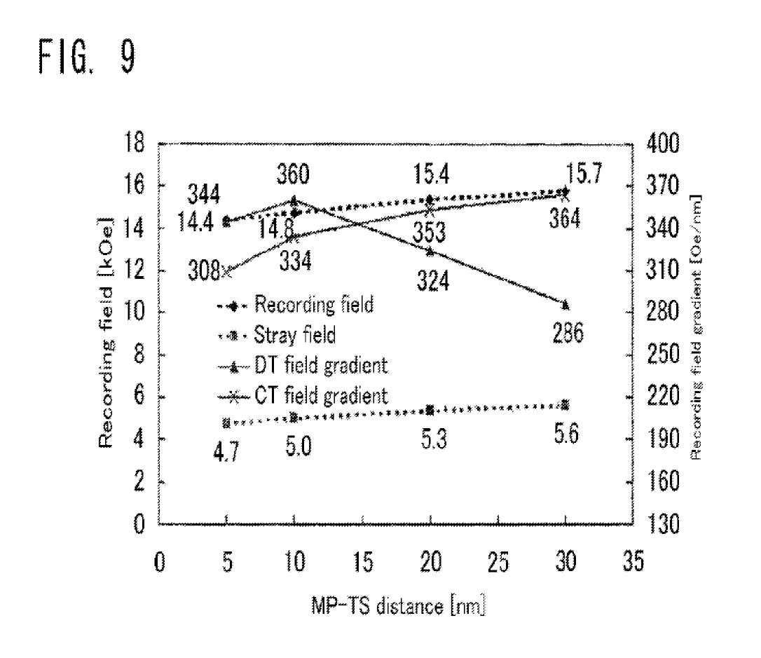

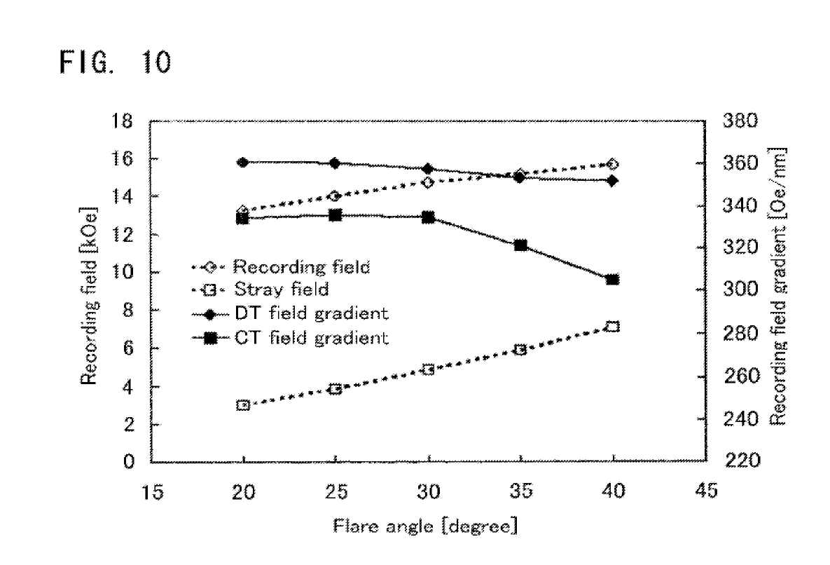

FIG. 9 is a graph depicting the dependencies on the MP−TS distance of the recording field strength, the recording field gradient in the down-track direction, the recording field gradient in the cross-track direction, and the stray field strength to the adjacent track, which were calculated by computer simulations, where the MP−SS distance was 10 nm.

It is shown from FIG. 9 that when attention is focused on the CT field gradient, the CT field gradient took the maximum value when the MP−TS distance is 30 nm, and the CT field gradient is reduced monotonously and becomes worse than the DT field gradient does near 15 nm. The DT field gradient took the minimum value when the MP−TS distance was 30 nm, and the maximum value near 10 nm, and the DT field gradient was reduced at 5 nm. In magnetic recording for HDDs, the DT field gradient is also essential to attain a high linear recording density, and it is really difficult to accept the degradation of the DT field gradient. Therefore, as similar to the description above, it is also confirmed from these simulations that the MP−SS distance has to be almost equal to the MP−TS distance for fitting a degradation of the DT field gradient in a small range.

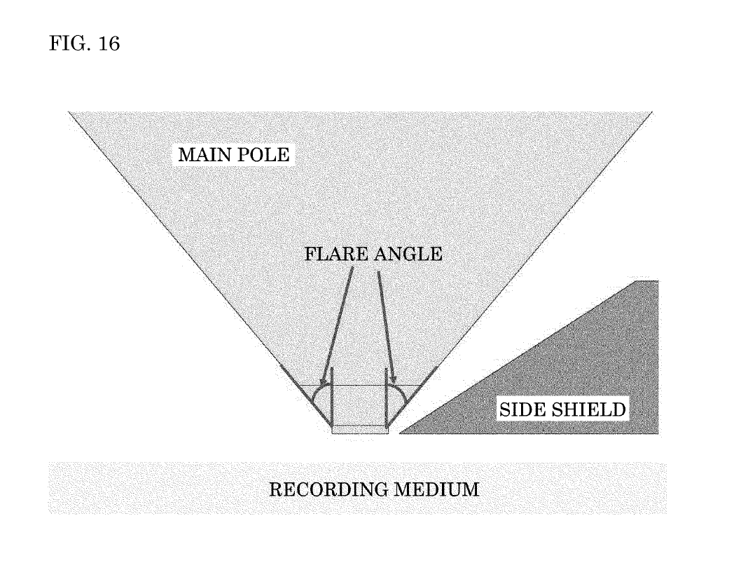

FIG. 10 is a graph depicting the dependencies on the flare angle of the main pole of the recording field strength, the recording field gradient in the down-track direction, the recording field gradient in the cross-track direction, and the stray field strength to the adjacent track, which were calculated by computer simulations. It is seen from FIG. 10 that when attention is focused on the DT field gradient, the optimum CT field gradient was obtained when the flare angle of the main pole ranged from angles of 20 to 30 degrees. The term “flare angle” means an angle formed between the normal of the bottom of the main pole and the side surface of the main pole as shown in FIG. 16.

### 2. Exemplary Embodiment

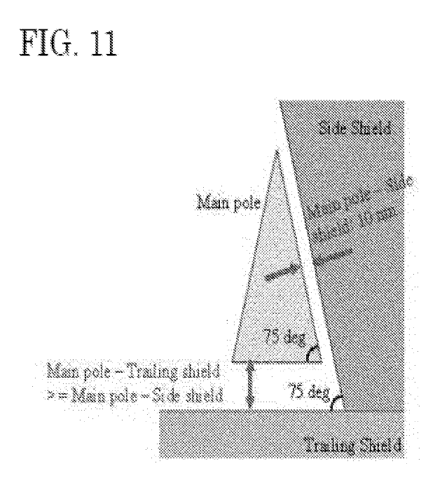

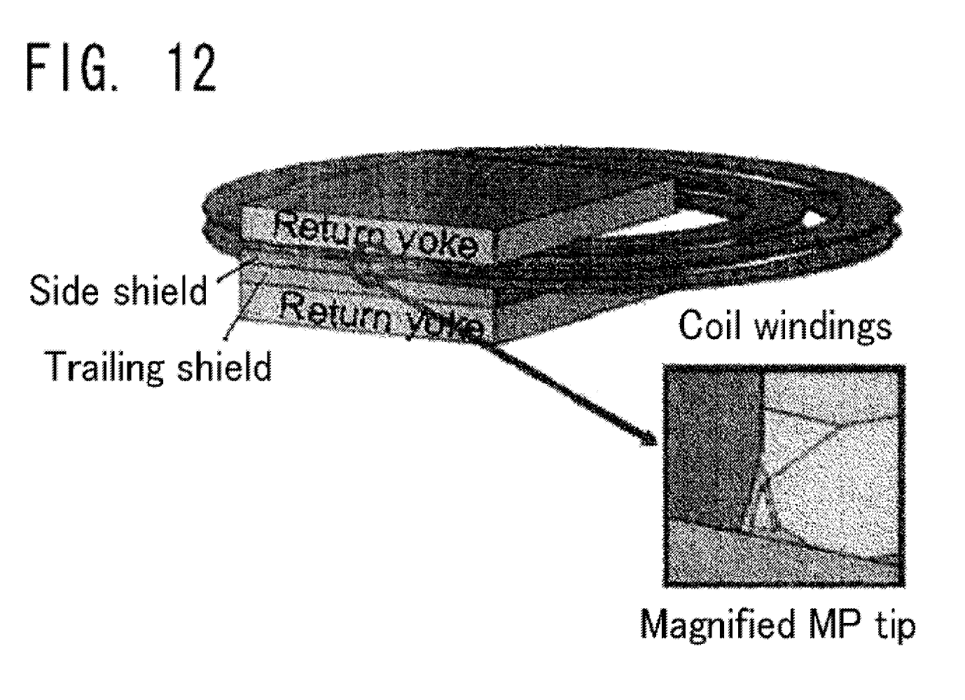

An exemplary embodiment of the first embodiment of the present invention is described with reference to FIG. 11. FIG. 11 is an enlarged diagram depicting a perpendicular magnetic recording head according to an exemplary embodiment of the first embodiment of the present invention seen from the air bearing surface (ABS). This perpendicular magnetic recording head is used for HDDs according to shingled write recording. The embodiment shown in FIG. 11 depicts the case in which a side shield is provided only on one side of the main pole, the flare angle of the main pole is formed to have an angle of 30 degrees, and the distance between the main pole and the side shield (MP−SS distance=10 nm) is formed equal to or below the distance between the main pole and the trailing shield (MP−TS distance). In this case, the shape of the air bearing surface (ABS) of the main pole is symmetric to the center line. In the embodiment shown in FIG. 11, the left and right base angles of the triangular main pole are formed to have an angle of 75 degrees. With this structure, the optimum values can be provided to the CT and the DT field gradients, and a higher track recording density can be attained than that of conventional technologies.

FIG. 12 is a schematic diagram depicting the outline of the overall perpendicular magnetic recording head according to the exemplary embodiment of the first embodiment of the present invention. As shown in FIG. 12, although the perpendicular magnetic recording head of this embodiment is formed of a main pole (MP), a return yoke, a trailing shield, a side shield, and coil windings, as similar to technologies before, FIG. 12 shows the structure in which the side shield is provided only on one side of the main pole.

### II. Second Embodiment

### 1. Structure of a Perpendicular Magnetic Recording Head

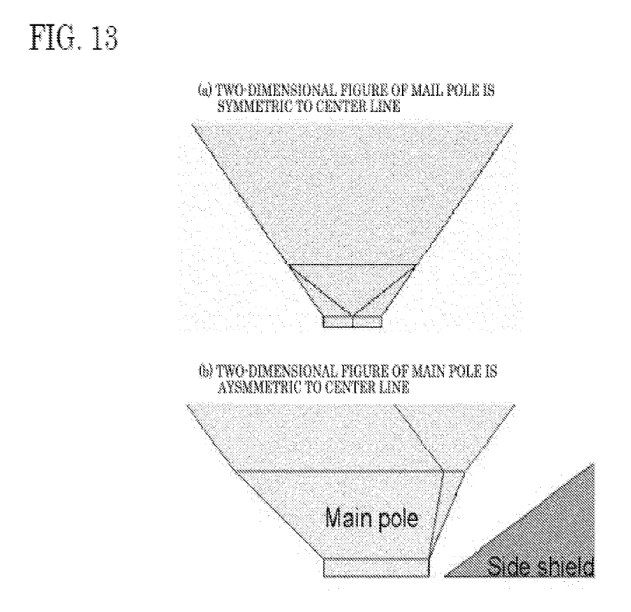

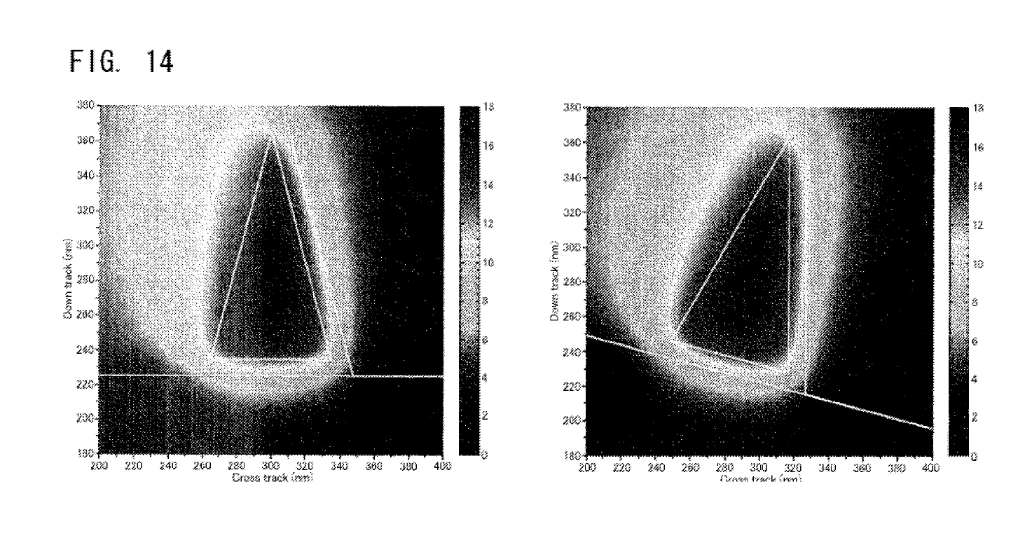

The structure of a perpendicular magnetic recording head according to a second embodiment of the present invention is described with reference to FIGS. 13A and 13B. Although the structure of the perpendicular magnetic recording head of this embodiment is basically the same as that of the first embodiment described in FIG. 7, the shape of the main pole is different, which is described.

FIG. 13A shows the shape that the two-dimensional figure of the main pole is symmetric to the center line. FIG. 13B shows the shape that the two-dimensional figure of the main pole is asymmetric to the center line. As shown in FIGS. 13A and 13B, the perpendicular magnetic recording heads according to the embodiments of the present invention have the shape that the two-dimensional figure of the main pole is symmetric or asymmetric to the center line.

As seen from FIG. 10, when the flare angle was an angle of 40 degrees, for example, the stray field from the main pole to the side shield was large. Consequently, the stray field to the adjacent track became large, and the CT field gradient became small. On this account, this is not preferable. It is an asymmetric model that the main pole is partially cut on the shielded side of the head for the intention to decrease the stray field to the adjacent track, while the flare angle, on whose side having no side shield, is kept at an angle of 40 degrees. The recording magnetic field and the recording field gradients of these structures (symmetric and asymmetric models) were calculated by computer simulations. The recording field strength was 15.9 kOe and 15.0 kOe for the symmetric model and the asymmetric model, respectively, and the recording field strength was slightly decreased in the asymmetric model. The DT field gradient was also 353 Oe/nm and 343 Oe/nm for the symmetric model and the asymmetric model, respectively, and the DT field gradient was decreased in the asymmetric model. In contrast to this, the stray field strength was 7.2 kOe and 4.2 kOe for the symmetric model and the asymmetric model, respectively, and favorably, the stray field strength was greatly decreased in the asymmetric model. Consequently, the CT field gradient was greatly improved as 309 Oe/nm and 359 Oe/nm for the symmetric model and the asymmetric model, respectively, and favorable results were obtained.

### III. Third Embodiment

### 1. Structure of a Perpendicular Magnetic Recording Head

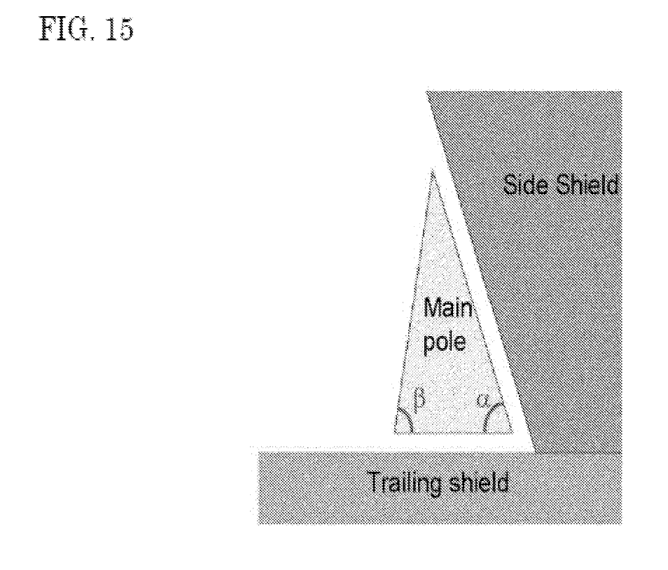

The structure of a perpendicular magnetic recording head according to a third embodiment of the present invention is described with reference to FIG. 15. Although the structure of the perpendicular magnetic recording head of this embodiment is basically the same as that of the first embodiment described in FIG. 7, the shape of the air bearing surface (ABS) of the main pole is different, which is described.

FIG. 15 shows the case in which the shape of the ABS of a main pole is asymmetric to the center line. At this time, it is important to satisfy a relationship:

α<β.

FIG. 15 shows the case, α=70 degrees and β=80 degrees.

Next, the recording field strength is described when the perpendicular magnetic recording head according to the first embodiment of the present invention has a skew angle (an angle at which the recording head is inclined toward a recording medium) with reference to FIG. 14. FIG. 14 shows recording field strengths determined at the center of the thickness of the recording medium at the skew angles of the recording head, 0 degree (left) and 15 degrees (right), by computer simulations, with the outlines of the main pole of the recording head, the side shield, and the trailing shield depicted. As seen from FIG. 14, the angle defined as an angle of 70 degrees in the first embodiment (FIG. 7) may be asymmetric. More specifically, it is sufficient that the left base angle of the triangular main pole is formed larger and the right base angle of the triangular magnetic pole, which is important for overwriting, is formed smaller.

The present invention is applicable to perpendicular magnetic recording heads for use in hard disk drives (HDDs).

1. A perpendicular magnetic recording head for use in shingled write recording, comprising:
a main pole that generates a recording magnetic field;
a trailing shield positioned on a trailing side of the main pole; and
a side shield positioned in a cross-track direction of the main pole,
wherein a gap length (MP−SS distance) between the side shield and the main pole and a gap length (MP−TS distance) between the trailing shield and the main pole satisfy a relationship:
(MP−TS distance)×0.5<(MP−SS distance)<(MP−TS distance)×1.5.

2. The perpendicular magnetic recording head according to claim 1, wherein the gap length (MP−SS distance) between the side shield and the main pole and the gap length (MP−TS distance) between the trailing shield and the main pole are almost the same.

3. The perpendicular magnetic recording head according to claim 1, wherein the side shield is provided only on one side of the main pole.

4. The perpendicular magnetic recording head according to claim 1, wherein a flare angle of the main pole, on whose side having side shield, ranges from angles of 20 to 30 degrees.

5. The perpendicular magnetic recording head according to claim 1, wherein a two-dimensional figure of the main pole is symmetric to the center line.

6. The perpendicular magnetic recording head according to claim 1, wherein a two-dimensional figure of the main pole is asymmetric to the center line.

7. The perpendicular magnetic recording head according to claim 1, wherein a shape of an air bearing surface (ABS) of the main pole is symmetric to the center line.

8. The perpendicular magnetic recording head according to claim 1, wherein a shape of an air bearing surface (ABS) of the main pole is asymmetric to center line.

9. The perpendicular magnetic recording head according to claim 2, wherein the side shield is provided only on one side of the main pole.

10. The perpendicular magnetic recording head according to claim 2, wherein a flare angle of the main pole, on whose side having side shield, ranges from angles of 20 to 30 degrees.

11. The perpendicular magnetic recording head according to claim 3, wherein a flare angle of the main pole, on whose side having side shield, ranges from angles of 20 to 30 degrees.

12. The perpendicular magnetic recording head according to claim 2, wherein a two-dimensional figure of the main pole is symmetric to the center line.

13. The perpendicular magnetic recording head according to claim 3, wherein a two-dimensional figure of the main pole is symmetric to the center line.

14. The perpendicular magnetic recording head according to claim 4, wherein a two-dimensional figure of the main pole is symmetric to the center line.

15. The perpendicular magnetic recording head according to claim 2, wherein a two-dimensional figure of the main pole is asymmetric to the center line.

16. The perpendicular magnetic recording head according to claim 3, wherein a two-dimensional figure of the main pole is asymmetric to the center line.

17. The perpendicular magnetic recording head according to claim 4, wherein a two-dimensional figure of the main pole is asymmetric to the center line.

18. The perpendicular magnetic recording head according to claim 2, wherein a shape of an air bearing surface (ABS) of the main pole is symmetric to the center line.

19. The perpendicular magnetic recording head according to claim 3, wherein a shape of an air bearing surface (ABS) of the main pole is symmetric to the center line.

20. The perpendicular magnetic recording head according to claim 4, wherein a shape of an air bearing surface (ABS) of the main pole is symmetric to the center line.
